(19) United States
(12) Patent Application Publication
(10) Pub. No.: US 2024/0035334 A1
(43) Pub. Date: Feb. 1, 2024

(54) RETRACTABLE SCREEN ASSEMBLY

(71) Applicant: Freedom Screens Capital Pty Ltd, Red Hill, QLD (AU)

(72) Inventors: Aaron Rodd, Red Hill (AU); Anthony Gerard Roberts, Red Hill (AU)

(21) Appl. No.: 18/265,349

(22) PCT Filed: Dec. 6, 2021
(86) PCT No.: PCT/AU2021/051453

§ 371 Date: Jun. 5, 2023

(30) Foreign Application Priority Data
Dec. 7, 2020 (AU) 2020904530
Aug. 25, 2021 (AU) 2021221708
Aug. 25, 2021 (AU) 2021221820

(51) Int. Cl. E06B 9/165; E06B 9/172; E06B 9/174; E06B 9/13; E06B 9/17

(52) U.S. Cl. CPC E06B 9/165; E06B 9/172; E06B 9/174; E06B 9/13; E06B 9/17007; E06B 2009/17092

(57) ABSTRACT

A screen retraction mechanism for a retractable screen assembly, the screen retraction mechanism comprising: a roller housing; a roller spinably mounted within the roller housing and for rolling a screen material sheet thereon; a torsion spring coupled to the roller for rotationally biasing the roller; and a tension adjuster coupled to an end of the torsion spring and configured to move in and out of engagement with the roller housing, wherein the tension adjuster is spinnable to selectably tension the torsion spring when out of engagement with the roller housing.

### TECHNICAL FIELD

The present disclosure relates to retractable screen assemblies for architectural openings, and particularly but not exclusively to screen retraction mechanisms for retractable screen assemblies for doors and windows. The present disclosure also relates to a latch mechanism for a retractable screen assembly for architectural openings, and particularly but not exclusively to latch mechanisms for retractable screen assemblies for doors and windows.

### BACKGROUND

Any references to methods, apparatus or documents of the prior art are not to be taken as constituting any evidence or admission that they formed, or form part of the common general knowledge.

Retractable screens that can be extended across an architectural opening and rolled away when retracted may allow an uninterrupted view and passage when retracted. Retractable screens may be installed across any suitable architectural opening including but not limited to window, doors, and between supports in outdoor areas such as pergolas, gazebos and the like, and may comprise insect screen material, privacy screen material or generally any suitable sheet of screen material.

Retractable screen assemblies may have a roller located within a roller housing. During withdrawal of the screen into the roller housing, the screen may be generally rolled onto the roller. The screen may be unrolled from the roller when the screen is extended out of the roller housing. The roller may generally be rotationally biased for retraction of the screen into the housing. The housing may be fixed to a side of an architectural opening. The screen may extend between the roller and a moveable draw bar that is manually moveable by a user's hand towards and away from the housing for retraction and extension of the screen. The retractable screen assembly may have guide rails for each end of the draw bar to guide the movement of the draw bar.

The retractable screen assembly may comprise a torsion spring for rotationally biasing the roller for withdrawal or retraction of the screen into the housing and tensioning the screen. The torsion spring may be pretensioned. The screen is drawn from the roller by manually pulling on the draw bar against the tension. Drawing the screen off the roller increases the tension of the torsion spring. When the drawbar is released, the tension in the spring draws the screen back onto the roller and back into the housing. If the torsion spring has too much tension, the draw bar and screen may retract too fast. By contrast, If the torsion spring tension is too low, the draw bar may return too slowly or may even not be able to retract at all.

The Applicant understands that in prior art arrangements, the spring may be pretensioned during manufacture and it may be difficult to adjust the spring tension after manufacture and once a screen has been installed. During manufacture, one end of the screen is attached to the draw bar and the other end to the roller. The screen may be hand-wound onto the roller and then be inserted through an open end of the roller housing. The open 15 end of the roller housing may then be closed by an end cap, which engages the end of the roller. The required tension for the torsion spring is dependent on a plurality of factors, which may include the size and weight of the screen, and the amount of friction between the guide rails and the draw bar. Consequently, the torsion spring is appropriately tensioned during manufacture to suit a specific retractable screen assembly design.

Kits of parts for retractable screen assemblies may also be made available. A kit may be configured for unskilled installers, for example, homeowners and other “Do it yourself” (“DIY”) installers. During installation, the size of the assembled retractable screen assembly may be changed by changing the length of upper and lower guide rails, for example, by trimming the rails or by using a telescoping action rail. Changing the size of a DIY retractable screen may generally necessitate some adjustment of the tension in the torsion spring. Whether adjustment of the torsion spring assembly is required may not be established or determined until the assembled screen assembly is installed. Consequently, any adjustment of the torsion spring tension would 30 require subsequent deinstallation or disassembly of the screen so that the end cap of the roller housing may be removed. This is time consuming and inconvenient. Yet further, retractable screen assemblies may be provided with varying arrangements to retain the draw bar when the screen is extended in view of the torsion spring bias, examples of which include a lock body at the drawbar and locking arms extending through the draw bar for actuating guide rail engaging brakes. Such locking arrangements may not be suitable for all retractable screen assemblies Additionally, the kit may be assembled around an architectural opening. For example, the upper guide bar may be first fixed to a wall before another kit part is mounted. Alternatively, the parts of the kit may be assembled prior, and the assembled screen assembly subsequently mounted at the architectural opening.

### SUMMARY OF INVENTION

In an aspect, the invention provides a screen retraction mechanism for a retractable screen assembly, the screen retraction mechanism comprising:
a roller housing;
a roller spinably mounted within the roller housing and for rolling a screen material sheet thereon;
a torsion spring coupled to the roller for rotationally biasing the roller; and
a tension adjuster coupled to an end of the torsion spring and configured to move in and out of engagement with the roller housing, wherein the tension adjuster is spinnable to selectably tension the torsion spring when out of engagement with the roller housing.

In an embodiment, the screen retraction mechanism comprises a torsion spring assembly comprising the torsion spring, and an end piece disposed at an end of the torsion spring, the end piece being in rotary engagement with the roller.

In an embodiment, the end piece is slidingly received within an end of the roller.

In an embodiment, the torsion assembly comprises another end piece disposed at another end of the torsion spring and coupled to the tension adjuster.

In an embodiment the screen retraction mechanism comprises a rotary damper assembly in rotary engagement with the roller. Preferably, an end of the rotary damper is slidingly received within the roller.

In an embodiment, the tension adjuster and the housing are cooperatively configured for dis engageable threaded engagement. Preferably, the housing comprises an end cap, wherein the end cap and the tension adjuster are cooperatively configured for dis-engagable threaded engagement.

In an embodiment, the tension adjuster comprises a thread having less than a pitch of thread.

In another embodiment, the tension adjuster comprises a plurality of intertwined threads.

In an embodiment, each of the plurality of intertwined threads has less than a pitch of thread.

In an embodiment, the torsion spring can be selectively tensioned to bias the tension adjuster inwards and into threaded engagement with roller housing.

In an embodiment, the roller housing comprises a longitudinal slot shaped screen material port.

In an embodiment, the tension adjuster is externally operable.

In another aspect, the invention provides a kit of parts that can be assembled into a screen retraction mechanism, the kit comprising: a roller housing; a roller for spinably mounting within the roller housing and for rolling screen material sheet thereon; a torsion spring for coupling to the roller for rotationally biasing the roller; and a tension adjuster for coupled to an end of the torsion spring and configured to move in and out of engagement with the roller housing, wherein the tension adjuster is for spinning to selectably tension in the torsion spring when out of engagement with the roller housing.

In another aspect, the invention provides a method of assembling a screen retraction mechanism, the method comprising the steps of: attaching a sheet of screen material to a roller for rolling the sheet of screen material thereon; spinnably mounting the roller within a roller housing; coupling the roller to a torsion spring; coupling a tension adjuster to the torsion spring; operating the tension adjuster to selectively tension the torsion spring; and engaging the tension adjuster to the roller housing.

In an embodiment, the step of operating the tension adjuster comprises the step of externally operating the tension adjuster.

In an embodiment, the step of spinnably mounting the roller within the roller housing comprises disposing the roller between a plurality of roller housing end caps.

In an embodiment, the step of engaging the tension adjuster to the roller housing comprises engaging the tension adjuster to one of the plurality of end caps.

In an embodiment, the step of operating the selectable tensioner comprises selectively tensioning the torsion spring to bias the tension adjuster inwards and into threaded engagement with roller housing.

In another aspect, the invention provides a latch mechanism for a retractable screen assembly, the latch mechanism comprising: a latch keeper; and a draw bar pivotably mounted for pivoting around a pivot axis and comprising a screen material sheet receiver for attachment of an edge of a screen material sheet, and further comprising a latch comprising a latch head engageable with the latch keeper, wherein the sheet screen receiver is displaced in a first orthogonal direction relative to the pivot axis and the latch head is displaced in a second orthogonal direction relative to the pivot axis, whereby tension in the screen material sheet when so received causes the latch head to pivot around the pivot axis into engagement with the latch keeper.

In an embodiment, the draw bar comprises an end cap comprising a rotary bearing at an outwardly orientated face thereof for pivotably mounting the draw bar. Preferably, the end cap comprises the latch head at an outwardly orientated face thereof.

In an embodiment, the end cap defines grooves for receiving a draw bar extrusion.

In an embodiment, the latch mechanism comprises a guide bar orthogonal to the draw bar and which defines a guiding channel in which the rotary bearing and latch head are slidingly received.

In an embodiment, the latch mechanism comprises another guide bar orthogonal to the drawbar, the guide bar and the other guide bar being at opposite ends of the drawbar, and another end cap associated with the other guide bar and comprising another rotary bearing and another latch head sliding received within another guiding channel defined by the other guide bar.

In an embodiment, the latch head is transversely smaller than the rotary bearing.

In an embodiment, the screen material sheet receiver comprises a slot for attaching the screen material sheet.

In an embodiment, the slot is configured to capture a bead.

In an embodiment, the latch keeper comprises a ramp having an inwardly directed apex for latching the latch head.

In an embodiment, the drawbar comprises a finger receiving part.

In yet another aspect, the invention provides a screen assembly for mounting to an architectural opening, the screen assembly comprising:
a peripheral frame comprising an architectural opening facing side, the peripheral frame comprising a plurality of mounting clip receivers at the architectural opening facing side and configured to removably engage a plurality of mounting clips for mounting the screen assembly at the architectural opening; and
a material screen sheet operationally coupled to the peripheral frame.

In an embodiment, the peripheral frame comprises a plurality of peripheral frame members defining a plurality of mounting clip receiving slots configured to slidingly receive the plurality of mounting clips.

In an embodiment, each of the plurality of mounting clip receiving slots extends along at least a major portion of an associated side of the plurality of sides.

In an embodiment, each of the plurality of mounting clip receivers comprise a plurality of lips that extend partially across a channel opening.

In an embodiment, the plurality of lips defines at least in part a recessed seat for receiving a body of one of the plurality of mounting clips.

In an embodiment, the plurality of mounting clips are penetrable by mechanical fasteners.

In an embodiment, each of the plurality of mounting clips comprise a plurality of resilient clipping projections on opposite sides of a body thereof for receipt by the plurality of mounting clip receivers.

In an embodiment, each of the plurality of mounting clips defines a reinforcing rib.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of an installed retractable screen according to an aspect of the .5 disclosure;

FIG. 2 is a view of the housing and drawbar assembly of the screen as shown in FIG. 1 prior to assembly of the screen frame,

FIG. 3 is a schematic view showing how the bottom track is joined to the housing;

FIG. 4 is a schematic view showing how the top track is joined to the housing;

FIG. 5 is a schematic view showing how the corner joiners are received onto the ends of the receiver bar;

FIG. 6 is a schematic view showing how the receiver is joined to the ends of the upper and lower tracks;

FIG. 7 is a schematic view of the completed screen frame as shown in FIG. 6, with the drawbar pulled across and locked into the receiver bar;

FIG. 8 is a schematic view of mounting clips being inserted into a profile on the rear of the housing, upper and lower guide tracks and receiver bar;

FIG. 9 is a detail from FIG. 8;

FIG. 10 is a cross section of a mounting clip and receiver bar from FIG. 9;

FIG. 11 is a perspective view of the mounting clip;

FIG. 12 is a cross section of the lower guide track with a clip mounted therein;

FIG. 13 is a schematic cross section of the lower guide track showing how fasteners may be used to mount the guide track to a support;

FIG. 14 shows the completed screen assembly prior to installation;

FIG. 15 is a top view of a draw bar end cap;

FIG. 16 is a bottom view of the draw bar end cap;

FIG. 17 is a rear view of the completed screen with the draw bar in the closed position adjacent the receiver bar;

FIG. 18 is schematic view showing the configuration of the draw bar cap and latch member approaching the closed position towards the receiver bar;

FIG. 19 is a schematic view of the drawbar cap as shown in FIG. 18 in a locking or unlocking configuration;

FIG. 20 is a schematic view of the drawbar cap shown in FIG. 18 in the locked position;

FIG. 21 is a view of the completed screen with an exploded view of the roller housing and components therein;

FIG. 22 is a cross section of the roller housing and components therein;

FIG. 23 is an exploded view of tension spring;

FIG. 24 is a perspective view of the upper end cap of the roller housing and associated 20 components;

FIG. 25 is an exploded view of the brake assembly;

FIG. 26 is a perspective view of the lower end cap of the roller bar and associated components;

FIG. 27 is a perspective view of the lower end cap of the roller housing and associated components

### DETAILED DESCRIPTION OF PREFERRED EMBODIMENTS

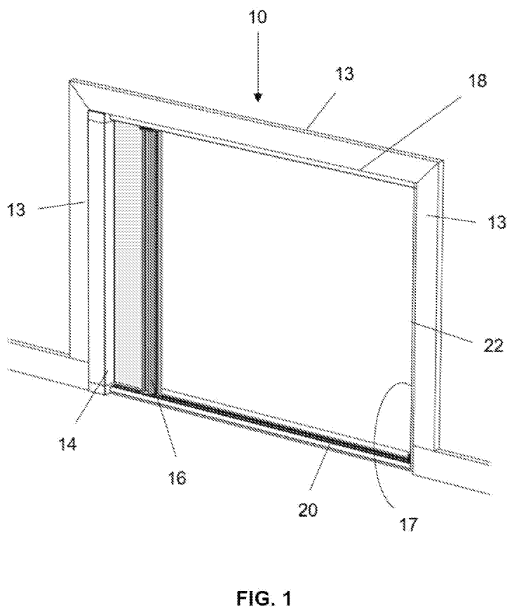

FIG. 1 shows an embodiment of retractable screen assembly generally indicated by the numeral 10 installed adjacent an architectural opening 12 in the form of a doorway. The retractable screen assembly 10 comprises a sheet of screening material 32 (“screen”), which in FIG. 1 is partially extended to partially close the doorway 12. In this embodiment, the screen 32 can be further extended such that a distal edge 15 thereof is adjacent a distal end 17 of the screen assembly 10 to close the doorway 12. The screening material 32 is in the form of fiberglass insect screen (“fly screen”). However, other embodiments comprise aluminium insect screen, privacy screen material, vinyl screens or generally any suitable and desired sheet of screening material. In other examples of use, the retractable screen assembly 12 may be installed adjacent an architectural opening in the form of a window, port, vent doorway or generally any 30 suitable form of architectural opening.

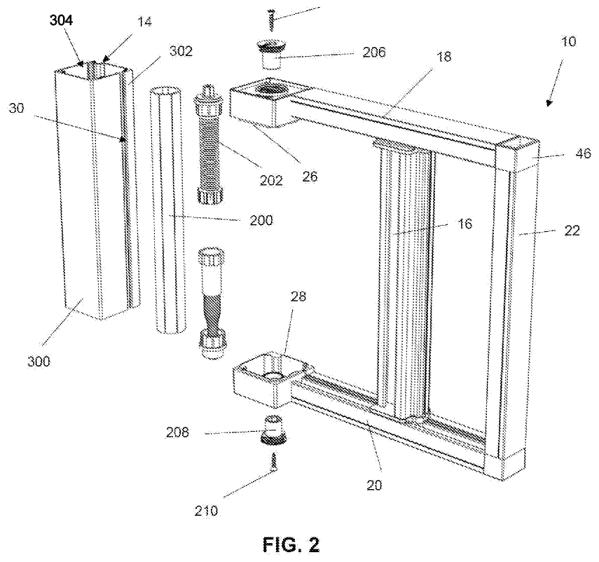

FIG. 2 shows a partial exploded view of the retractable screen assembly 10, with the sheet of screen material 32 hidden and dimensions rescaled for illustrative purposes. The retractable screen assembly 10 comprises a roller housing 14 that is elongated and defines a cavity 304. Disposed in the cavity 304 is a roller 200 in the form of a tube onto which the sheet of screening material 32—which is generally flexible—can be rolled for retraction of the sheet of screen material 32 into the roller housing 14. The sheet of screen material 32 can be unrolled from the roller 200 for extending the screen 32 across the architectural opening 12. The roller 200 is operationally coupled to a torsion spring assembly 202, one end of which is disposed in the roller 200 and engages an internal wall surface thereof. The roller can be rotationally biased by the torsion spring assembly 202 for retraction of the screen 32 into the roller housing 14. The torsion spring is fixed to the roller housing at the other end as will be described in more detail below.

The retractable screen assembly 10 comprises a draw bar 16 parallel to the roller housing assembly and attached to the sheet of screen material 32 (which in FIG. 2 is hidden for illustrative purposes). The draw bar 16 is manually actuatable by a user's hand, for example, for extending and withdrawing the sheet of screen material 32 across the opening.

As seen in FIG. 2, the screen assembly 10 comprises a top guide rail 18 and another bottom guide rail 20 that is parallel to the guide rail 18 and perpendicular to the draw bar 16 and roller housing assembly. In this embodiment, the guide rail 18 is at the top of the architectural opening (“upper guide rail”) and the other guide rail 20 is at the bottom of the opening (“bottom guide rail”) and parallel to the guide rail 18. However, the guide rails 18,20 may be alternatively vertically orientated for vertical movement of the screen 32 or have generally any other suitable orientation. The draw bar 16 is slidingly engaged with the guide rails 18,20. The guide rails 18,20 are provided for guiding movement of the drawbar 16, and generally restrict translation of the draw bar 16 to a linear translation.

The retractable screen assembly 10 comprises a receiver bar 22 configured to latchingly engage the draw bar 16 and so retain the sheet of screen material 32 in the extended state and close the architectural opening. The receiver bar 22 is attached to the guide rails 18,20 by joiners 44,46 in the form of end caps. 30

The retractable screen assembly 10 in the illustrated embodiments can be assembled in the vicinity of the architectural opening (“that is on site”). The guide rails 18, 20, roller housing 14 and receiver bar 22 are each cut to a suitable length for the architectural opening on site.

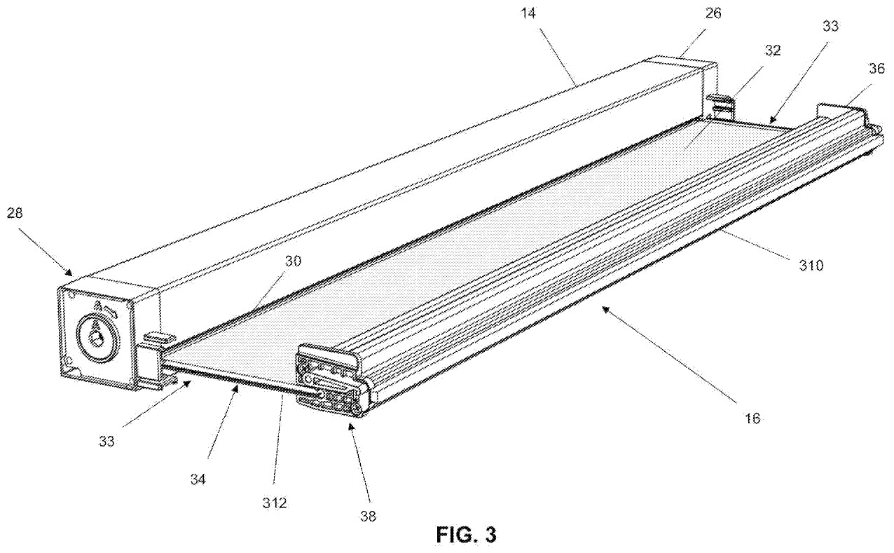

FIG. 3 shows parts of an assembled kit comprising the roller housing 14, the roller 200, which is disposed in the roller housing 14, the draw bar 16, and the sheet of screen material 32, which is rolled around the roller 200 and also attached to the draw bar 16. The drawbar 16 comprises an elongate aluminium extrusion 310 with an upper end cap 36 and a lower end cap 38. The kit can comprise the upper and lower guide rails 18, 20, receiver bar 22 (See FIG. 2), end caps and joiners 44,46 which are supplied as separate component parts.

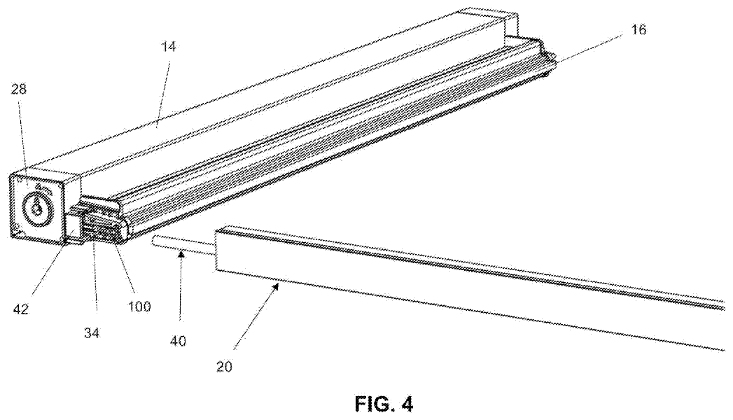

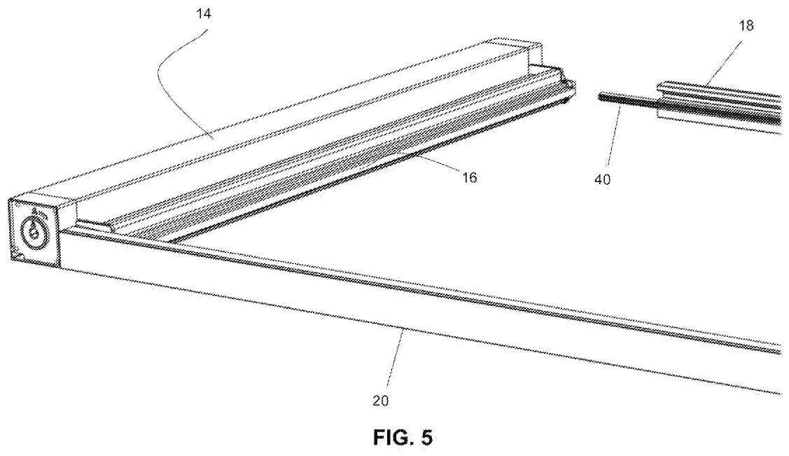

As can be seen in FIGS. 2 and 3, the roller housing 14 comprises a plurality of angles 300,302, and upper and lower end caps 26, 28. The angles 300, 302 comprise extruded aluminium alloy. However, it may also comprise polymer or any other suitable material. When joined by the end caps 26,28, the roller housing 14 defines a longitudinal slot shaped screen port 30 through which the screen 32 passes. Upper and lower edges 33 of the screen 32 each comprise a bead 312 to thicken the edge. The beads 312 are each in the form of a line of zipper teeth, (which can be formed from a length of zipper tape 34) attached along the respective edge of the sheet of screen material 32. Alternatively, the bead 312 may comprise a polymer strip or generally be any other suitable bead. As understood with reference to FIGS. 3 and 4, the teeth along the length of the zipper tape 34 are retained by elongated bead retaining members 40 in the upper and lower guide rails 18, 20. The bead retaining members 40 define a longitudinal slot through which the sheet of screen material passes but which is too narrow to allow the bead 312 to be pulled therethrough. This arrangement keeps the sheet of screen material 32 taut, preventing screen “blow out”, while still allowing sliding movement of the beads 312 within the bead retaining members 40.

The bead retaining members 40 are made from a polymer material, which may reduce sliding friction between the beads 312 and the bead retaining members 40. The bead retaining member 40 can be slid out of the guide rail 20 and fed onto the zipper 34 at the lower edge of the screen. Alternatively, or additionally, the zipper 34 can be fed into the bead retaining member 40. The guide rail 20 is then pushed onto a mating tab 42 on the lower end cap 28 of the roller housing 14 to attach the guide rail 20 to the mating tab 42 by a friction fit. Mechanical fasteners, adhesive or generally any suitable form of attachment may be alternatively used.

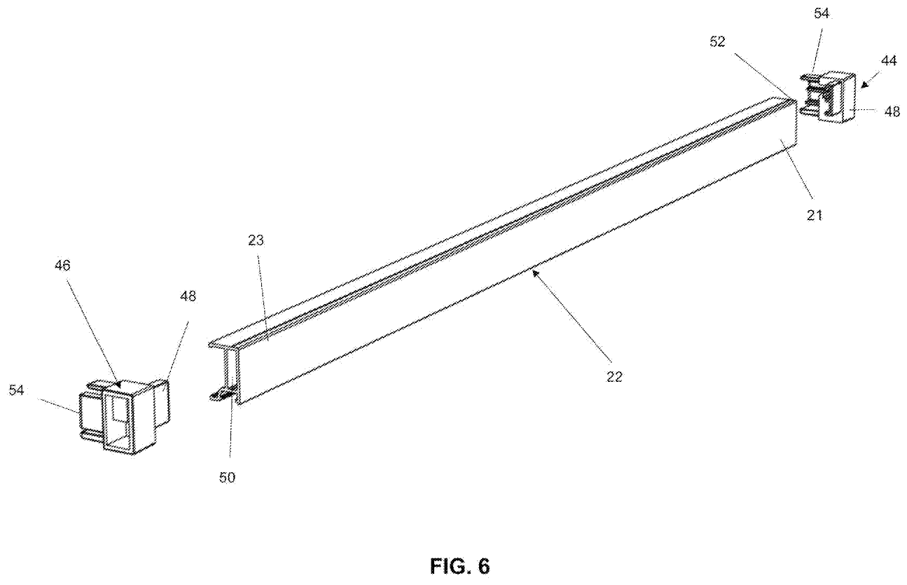

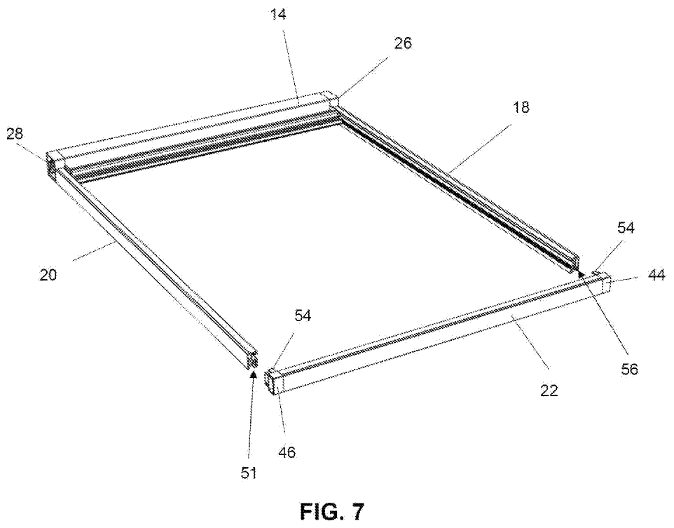

FIG. 6 shows upper and lower joiners in the form of end caps 44, 46 being fitted to the upper and lower ends 21, 23 of the receiver bar 22. The receiver bar 22 is an elongate extrusion with an uneven profile visible in FIG. 6. Each end cap 44, 46 has a first projecting tab 48 configured to be received within a complementary recess 50, 52 at each end of the receiver bar 22. Each end cap 44, 46 has a second projecting tab 54 that is received within a complementary recess 56, at the end of the upper and lower guide rails 18, 20 as shown in FIG. 7. The projecting tabs 54 are attached to the guide rails 18,20 and receiver bar 22 by a friction fit. Mechanical fasteners, adhesive or generally any suitable form of attachment may be alternatively or additionally used. The tab 54 has the same configuration as the mating tabs 42 on the upper and lower end caps 26, 28 of the housing 14.

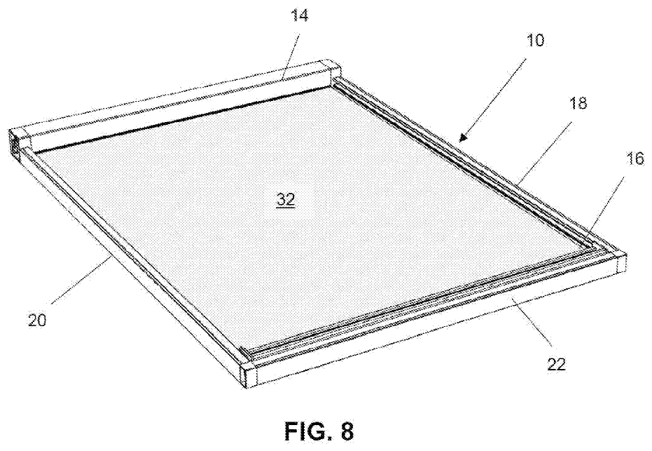

FIG. 8 shows an isometric view of the front of the assembled screen assembly with the draw bar 16 pulled across to close the assembly passageway defined by 14, 18, 20 and 22. The draw bar 16 is latchingly engaged with the receiver bar 22. This configuration provides stability to the screen assembly 10 for further handling and mounting to a doorway. As shown in FIG. 28 and explained in foregoing sections, the drawbar 16 can also be optionally latchingly engaged at an intermediate position along guide rails 18 and 20 to allow the screen 32 to be in a partially open/closed position where the drawbar 16 engages an intermediate member 500. The working of the intermediate member 500 will be described in detail in the foregoing sections.

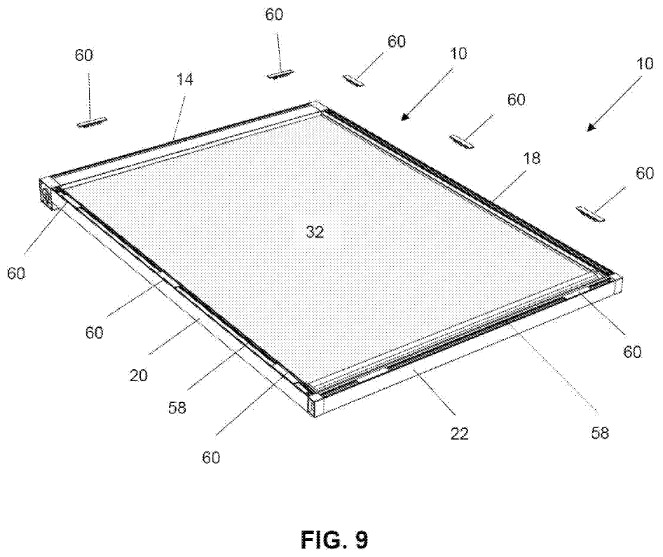

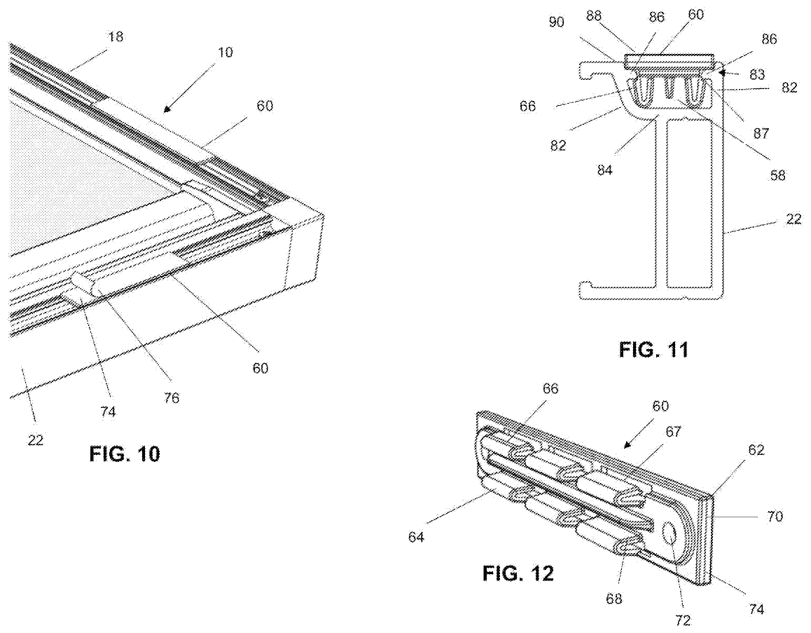

FIG. 9 shows an isometric view of the rear of the screen assembly 10 which is generally orientated towards the architectural opening 12 and mounted to a structure in the form of an architrave or trim surrounding the architectural opening 12 when the screen assembly is installed. The rear walls of each of the housing 14, upper and lower guide rails 18, 20 and receiver bar 22 define an elongate channel 58 configured to engagingly 20 receive at least one mounting clip 60 therein, the engagement being in the form of a snap fit engagement. FIG. 10 shows a detail of the upper right-hand corner of the screen assembly of FIG. 9, with a mounting clip 60 received by each of the receiver bar 22 and guide rail 18. For mounting the screen assembly 10, adhesive 74 in the form of a length of double-sided tape is attached to the rear of each of the plurality of mounting 25 clips 60. The rear face of the double-sided tape comprises a removable protector liner 76 in the form of a strip, that can be removed to reveal the adhesive.

FIG. 11 shows a section of the receiver bar 22 with the clip 60 engagingly received thereby. The clip channel 58 in the receiver bar 22 can be a U-shaped channel. The clip channel 58 has opposing side walls 82, a base 84 and lips 86 that extend partially 30 across the open end 88 of the channel 58. As seen in FIG. 11, the clip 60 comprises at least one clip tab 66 in the form of a leg. During insertion into the channel 58, the outer legs 66 of the clip 60 deform to deflect inwardly as they are pushed past the lips 86, and then relax outwardly when fully inserted so that free ends 87 are captured behind lips 86 to form a snap fit connection. The lips 86 and upper part of the side walls 82 define a ledge part 90 with a recessed seat 83 that receives the body 62 of the clip 60. The recessed seat 83 and body 62 are cooperatively configured to, when engaged, resist lateral movement of the installed clip 60.

FIG. 12 shows an isometric view of the rear of a mounting clip 60. The mounting clip 60 has a rectangular planar body 62. A plurality of clip elements 64 in the form of a linear array of three inverted U-shaped resilient projections 64 extend longitudinally along 10 opposite longitudinal sides the body 62. Each projection 64 has opposed outer and inner leg parts 66, 68. The U-shaped projections are connected to the base by the inner leg 68 only such that a gap 67 is defined between the outer leg 66 and the base 62. The mounting clip 60 comprises a central longitudinal reinforcing rib 70. The mounting clip 60 also has a fastener receiving aperture 72 at each end for receiving a mechanical fastener in the form of a screw or generally any suitable form of fastener, for example, a rivet. After the clips 60 have been installed in the respective channels 58,59 the protective strip 74 is removed so as to expose the adhesive 74. The screen assembly 10 can then be placed in the door frame 13 as shown in FIG. 1 and held in place by the adhesive 74 of the clips 60 on the door assembly. Mechanical fasteners in the form of screws, bolts, or generally any form of suitable fastener can then be used—instead of or additional to the adhesive 70 to attach the screen assembly 10 to the structure adjacent the architectural opening 12.

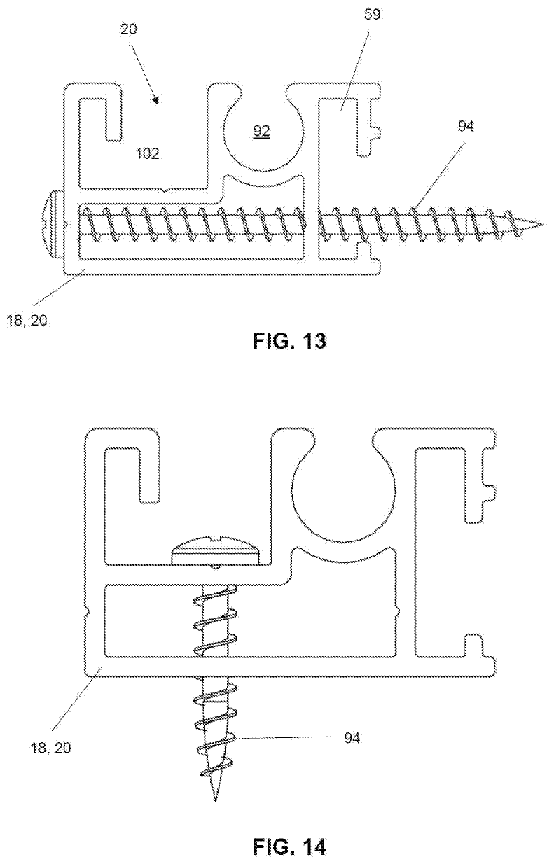

FIGS. 13 and 14 are cut away views showing mounting screws penetrating a guide rail 18, 20 which can be screwed into the door frame or other 25 suitable adjacent structure. The latching of the draw bar 16 to the receiver bar 22 will now be described.

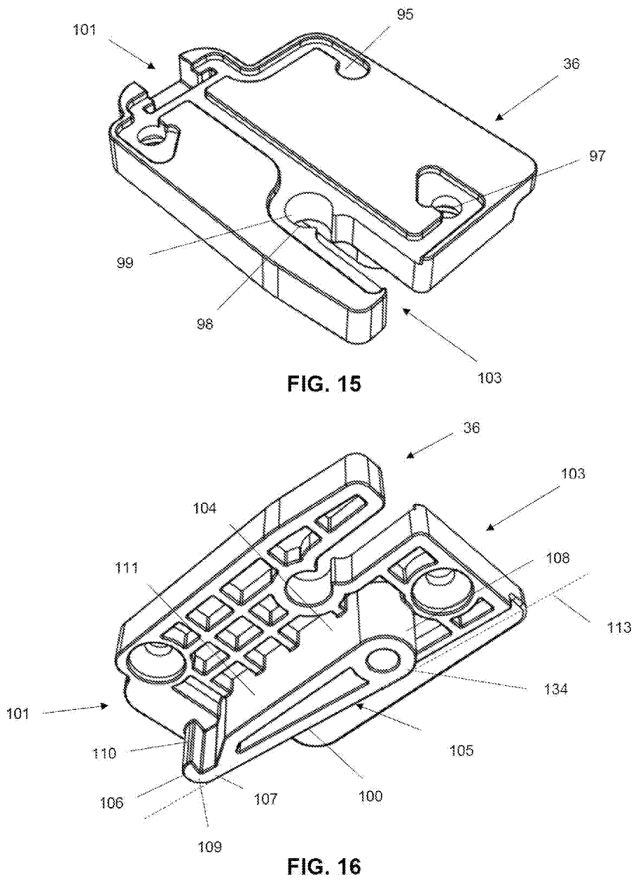

FIGS. 15 and 16 respectively show isometric views of the inwardly orientated face and outwardly oriented face of the end caps 36, 38 of the draw bar 16. Each of the end caps 36,38 has the same configuration. The inwardly orientated face of each end cap 36, 38 defines grooves 95 that are complementary to the profile of the draw bar 16 extrusion for receiving an end of the draw bar 16 extrusion and locating the end of the draw bar 16 extrusion with respect to the end cap 36,38.

Each end cap 36 has a leading end 101 directed to the receiver bar 22 and a trailing end 103 directed to the roller housing 14. The trailing end 103 has a longitudinal slot 98 that terminates in a rounded slot end 99 to form a keyhole shaped slot. In use, the rounded end 99 part retains the bead 312 of the screen 32. Alternatively, or additionally, the edge of the screen 32 can be fastened within the slot 98 with adhesive. The end caps 36, 38 further define fastener receiving apertures 97 for fastening the end caps 36,38 to the draw bar 16. As seen in FIG. 16, a latch member 100 in the form of a latch arm that is elongated and tapered is located on the outwardly orientated face of the end cap 36. In use, the latch member 100 is slidingly received within the channel 102—shown in FIG. 15 of the lower guide rail 20. The latch member 100 has a body 104 with a leading end 106 in the direction of travel towards the receiver bar 22 and a trailing end 108. The leading end 106 terminates in a latch head 110 in the form of a hook part 110. The body 104 of the latch member 100 has opposed lateral walls 105,111. The wall 105 is parallel to the longitudinal axis of the end cap 36 and terminates in the shank 107 of the hook part 110. The front wall 111 is inclined relative to the wall 105.

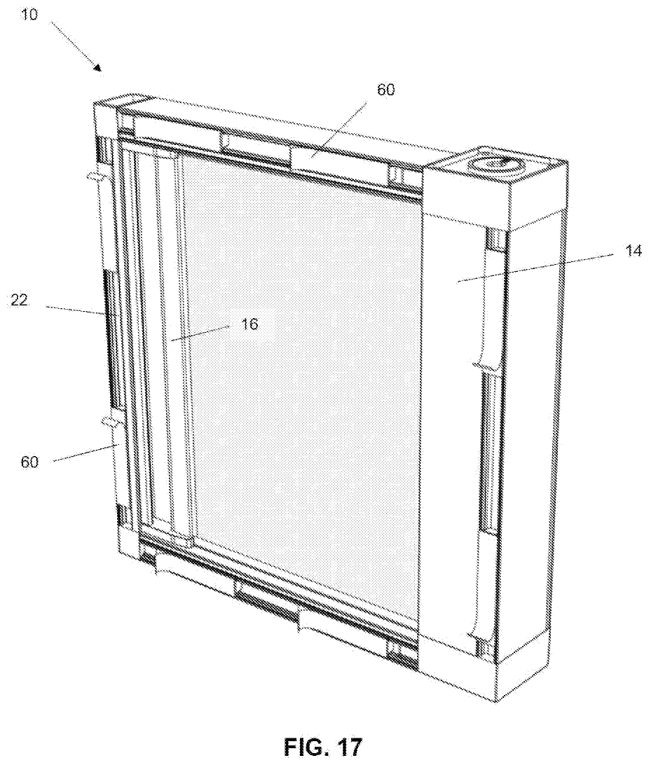

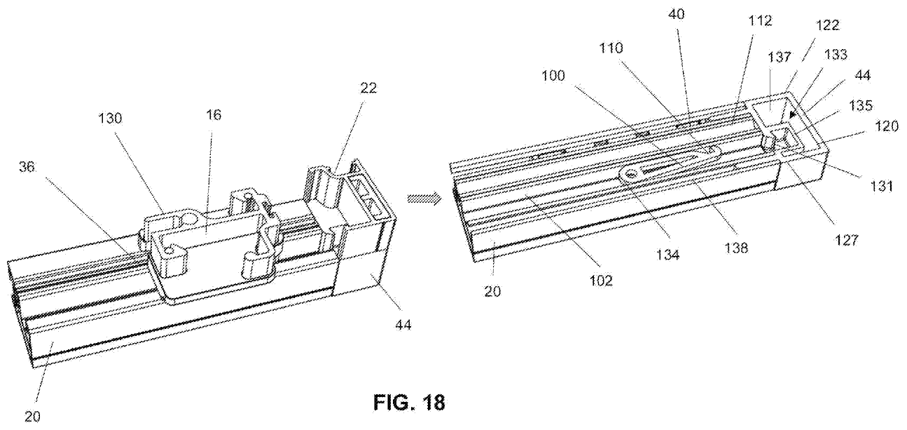

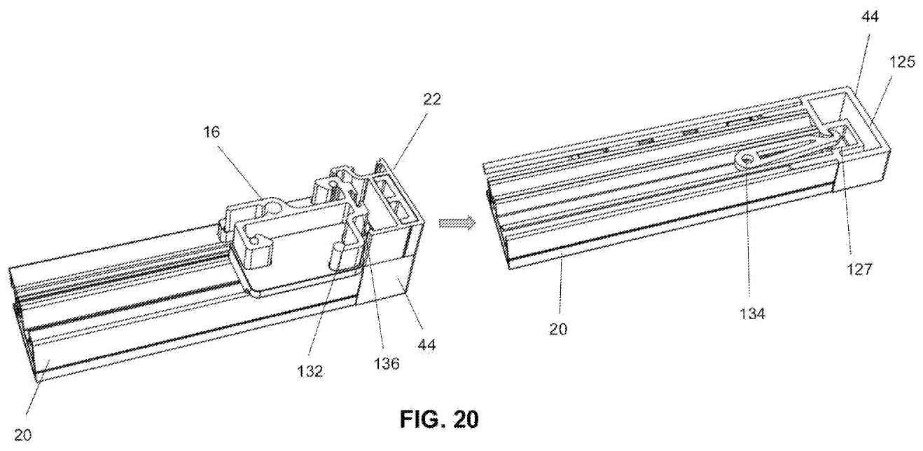

FIG. 17 shows an isometric view of the rear of the screen assembly 10, without the screen 32 for illustrative purposes, wherein the draw bar 16 is in a closed position and latchingly engaged to the receiver bar 22. FIGS. 18 to 20 show cut away views of the draw bar 16, lower guide rail 20 and guide rail end cap 44, during latching of the draw bar 16 to the receiver bar 22. The right-side drawings are cut through a lower plane than the left side drawings. The draw bar 16 defines a rear slot 130 for receiving another bead (not shown) at the distal edge of the screen 32. The draw bar 16 has a finger receiving part 132 in the form of a handle adjacent the leading edge 136 for a user to actuate the draw bar 16. In use the, latch member 100 extends into and travels along channel 102 of the lower guide rail 20 as may be seen in FIGS. 18 to 20. The trailing end 108 has a protruding bearing part 134 in the form of a slidingly received protruding rotary bearing 134 that has a transverse dimension substantially the same as the width of the channel 102. Thus, the rotary bearing 134 of the latch member 100 is captured within the channel 102 and also functions as a guide for the draw bar 16.

The channel 102 is defined by lateral side walls 136, 138 including a rear side wall 136 and a front side wall 138. As the rear wall 105 of the latch member 100 is parallel to the longitudinal axis of the latch member 100, the rear wall 105 is generally aligned with the wall 138 of channel 102. The inclined wall 103 is inclined away from the wall 138 of the channel 102.

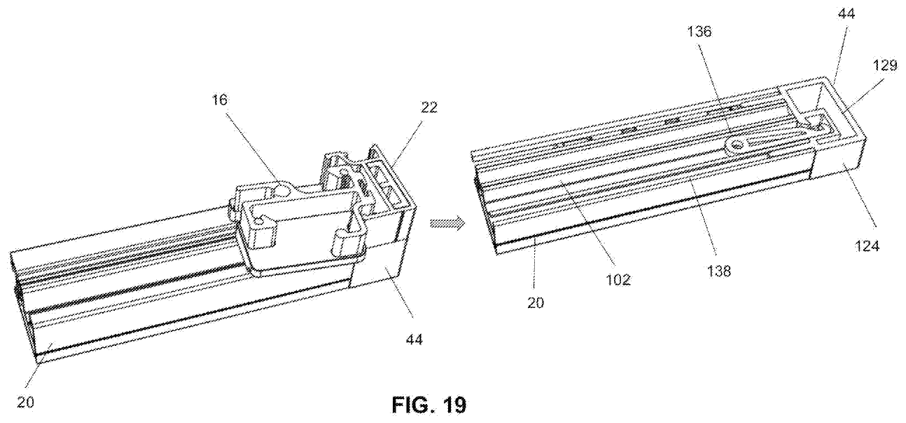

The draw bar can pivot around the bearing part 134 as shown in FIGS. 18 and 19. The bead of the screen 32 inserted into the slot 130 is laterally displaced relative to the bearing part 134, and consequently exerts a torque on the draw bar 16 around the bearing part 134 to rotate the latch member 100 into engagement with then receiver part 120 in the form of a latch keeper of the end cap 44 that couples the receiver bar 22 to the lower guide rail 20. The latch member 100 enters the latch keeper 120 through entrance aperture 127. The receiver part 120 is configured to communicate with channel 102 of the guide rail 20.

The latch keeper 120 comprises a ramp having an inwardly directed apex 131 to define a rear hook receiving cavity 137. The end cap 44 has a rear side wall 122 side (with respect to the rear of the guide rail) and a front side wall 131 and an end wall 125 connecting the rear side wall 122 and the front side wall 131. As shown in FIG. 19, when the hooked leading edge 110 of the latch member 100 meets the ramp 120, the hook 110 rides over the ramp so as to cause the draw bar 16 to pivot against the bias as shown in FIG. 19. When the hooked part 110 passes the latch keeper 120, the bias of the screen returns the latch member 100 into an engaged position on the latch keeper 120 so as to latch the draw bar 16 to the receiver bar 22.

A user can disengage the draw bar 16 by actuating the handle 132 of the draw bar 16 to rotate the draw bar and disengage it from the receiver bar 11. The tension in the biased screen 23 can then withdraw the screen 32 into the roller housing 14. The mechanism for adjusting the tension of the screen 23 is now described in more detail. As seen in FIG. 2, a roller 200 inside the roller housing 14 has a generally round outer surface around which the screen 32 is rolled when retracted. Disposed within the roller 200 is a torsion spring assembly 202 for rotationally biasing the roller 200. A rotary damper assembly 204 in the form of a viscodynamic brake (for example, a viscodynamic brake manufactured by AQUS, Italy) is also enclosed within roller 200 so as to slow or brake retraction of the roller 200. Other damper or brake mechanisms may be used, for example a linear friction bearing.

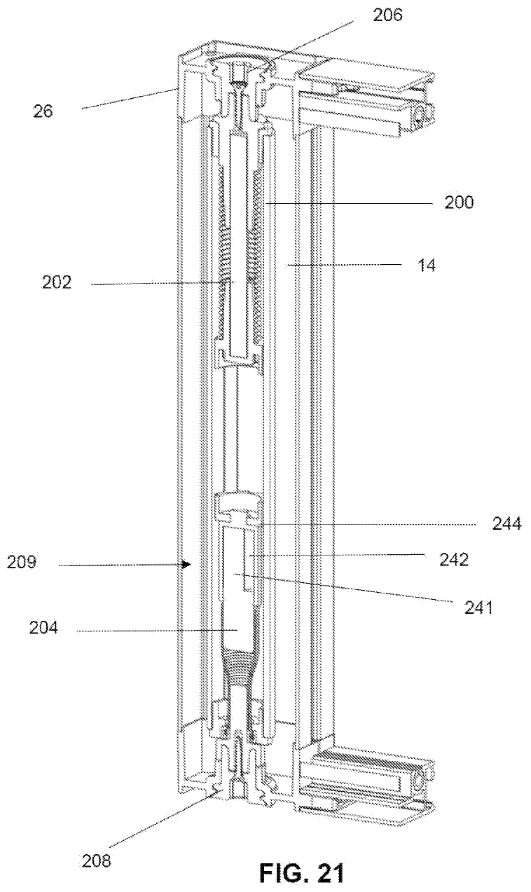

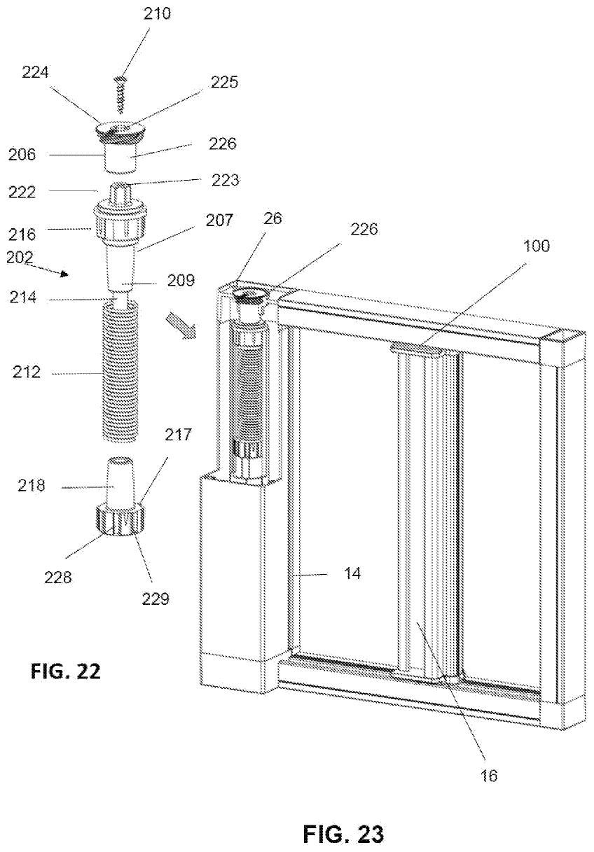

The torsion spring assembly 202 and rotary damper assembly 204 are secured to the upper and lower end caps 26, 28 of the roller housing 14 by means of upper and lower adjustment and connecting members 206, 208 and screws 210 as will be described further below. FIG. 21 is a cut away view of the roller 200, spring assembly 202 and rotary assembly 204 installed within the roller 14. FIG. 22 shows an exploded view of the torsion spring assembly 202 and FIG. 23 shows a partial cut away view showing the torsion spring assembly 202 installed in the roller housing 14. Disposed within the torsion spring assembly 202 is rod 214. An end piece in the form of a lower end cap 228 and another end piece 207 in the form of a head part are disposed at opposite ends of the torsion spring and capture the rod 214 within the torsion spring 212. The lower end cap 228 has a circular base 217 and an upstanding inwardly tapered sleeve 218 that receives the lower end of the rod 214. The upper cap 206 comprises a separable head part 207 and a tapered sleeve 209 for receiving an upper end of the rod 214.

As shown in FIG. 23, the head 207 has a hexagonal projection 222 with a central bore 223. The roller 200 slidingly receives the end cap 228 such that it is rotationally engaged. The circular base 217 of the lower end cap 228 has vertical ribs 229. The roller 200 has complementary internal ribs (not shown) that that engage ribs on the cap 228 such that rotation of the roller 200 will cause the lower cap 228 to rotate. Alternatively, or additionally, keys or splines may be used to rotationally engage the roller 200 and the circular base. 217. The roller 200 can be cut to size and still generally receive the end cap 228.

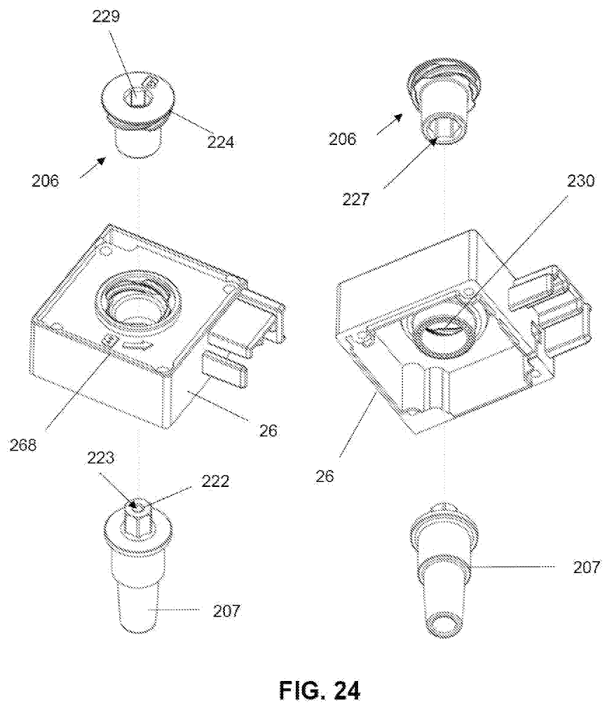

FIG. 24 shows top and bottom isometric views of the upper end cap 26 of the roller housing, the upper cap 216 and a tension adjuster 206. The tension adjuster 206 can be rotated to tension the spring. The external face of the cap 26 has an arrow 268 (as seen in FIG. 24) that indicates the direction of rotation for increasing torsion in the torsion spring 212 and the tension in the screen. The upper end cap 26 and in turn the upper part of the spring 212 are prevented from rotating as the upper end cap 26 is held in place by connection to the adjustment member 206 that is, in turn, in threaded engagement with the upper part of spring assembly 202.

Tension adjuster 206 comprises a plurality of intertwined or overlapping threads. Each of the plurality of threads optionally comprise less than a pitch of thread. That is, each of the plurality of intertwined threads do not make a full turn or revolution around an axis of the tension adjuster 206. The tension adjuster may comprise only one thread in some other embodiments. A proximal edge of the screen 32 is fixed to the roller 200 by an adhesive in the form of adhesive tape. However, it may be fixed using a clamping strip, fasteners in the form of screws, or generally any suitable way of fixing. As the roller 200 rotates one way the screen 32 is extended from the roller housing 14, one end of the torsion spring 212 associated with the end cap 26 is caused to rotate with the roller 200 whereas the other end of the spring 212 associated with the lower end cap 28 is held stationary. The torsion spring 212 can be pretensioned. To pretension the torsion spring 212, the upper part of the torsion spring 212 is rotated without movement of the lower part of the spring 212. As shown in FIG. 23 the spring assembly 202 is operationally coupled (in this embodiment indirectly connected) to the upper roller housing end cap 26 by means of the connection between the upper end cap 26 and the tension adjuster 206. The tension adjuster 206 is in the form of a cap with a circular head 224 attached to a lower cylindrical body or shank 226. As shown in FIG. 23, the cylindrical body 226 has a hexagonal aperture 227 for receiving and engaging the hexagonal projection 222, thereby providing a socket type connection. The tension adjuster 206 is externally operable so that it can be accessed from outside of the roller housing 14 without opening the housing 14. The head 224 also has a hexagonal recess 225 for receiving the head of a complementary tool in the form of a hex key that can be actuated to rotate the tension 25 adjustment member 206. The tension adjuster 206 defines an aperture 229 for receiving a fastener in the form of a screw 210 that threadingly engages projection 222 so as to secure the parts together and prevent rotational movement of the upper cap 26 relative to the upper end of torsion spring assembly 202. In the present embodiment, but not necessarily in all embodiments, it is not necessary to roll the screen onto the roller prior to insertion of the roller into the roller housing. The roller 200 may be inserted into the housing 14 with the draw bar 16 spaced away from the housing 14 by the screen 32. The end cap 26 may then be fitted to the upper end of the roller housing 14 and the tension adjuster 206 inserted through the bore 230 of the end cap 26 until the hexagonal projection 222 is received within bore 227 of the tension adjuster 206.

The tension adjuster 206 can subsequently be rotated so as to roll the screen onto the roller 200 within the roller housing 14. As the upper and lower ends of the torsion spring 212 are free to move, no tension is generated during this process. When the screen 32 has been fully rolled onto the roller 200, and the draw bar 16 is adjacent to the roller housing 14, the roller housing 14 interferes with the draw bar 16, preventing further rotation of the roller. At this point, tension may be applied to the torsion spring 212 by continuing turning the tension adjuster 206. When the desired degree of tension has been obtained, the tension adjuster is secured against further rotation or movement by threadingly engaging the tension adjuster 206 and the upper cap 26. The adjuster 206 is then secured in place by a screw 210 that is received within a complementary bore 223 in the hexagonal projection 222. The spring 212 is in a longitudinally compressed state. The screw 210 locks the tension adjuster 206 adjacent the upper end cap 26, which prevents a longitudinal bias of the spring pushing the tension adjuster 206 all the way out of the end cap 16 during the tensioning procedure. The longitudinal bias of the spring 212 allows the torsion spring assembly 202 to at least partially extend out of the end cap 26 during tensioning. As the tension is increased, the spring 212 shortens to withdraw the tension adjuster 206 into the endcap 26. The torsion in the torsion spring 212 causes the tension adjuster 206 to automatically screw into the end cap 26, securing of the tension adjuster 26.

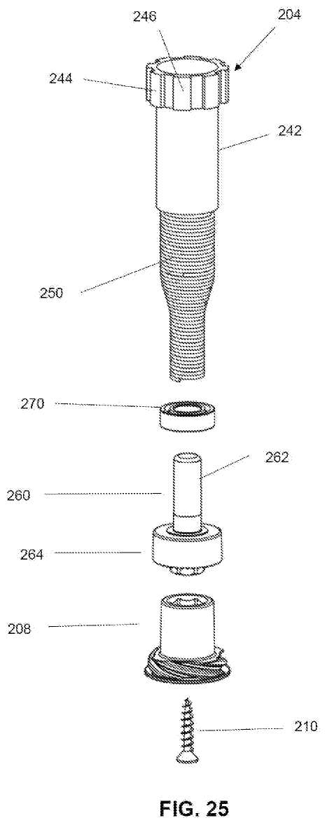

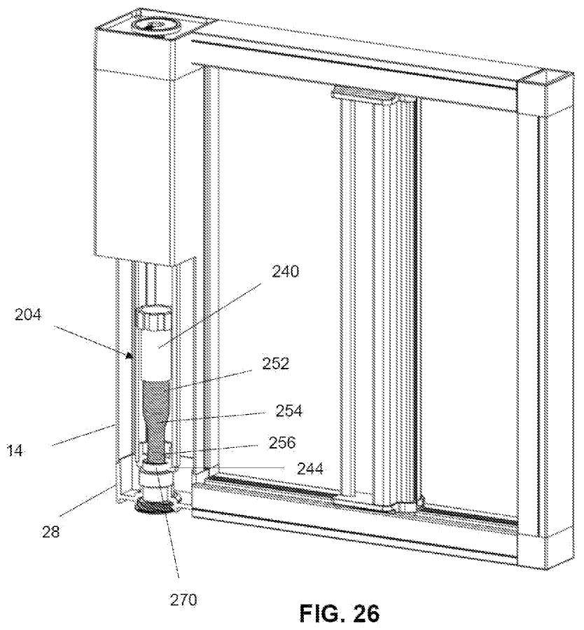

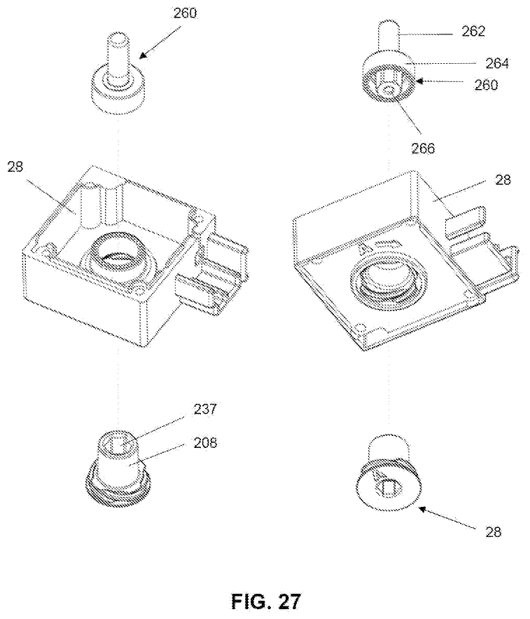

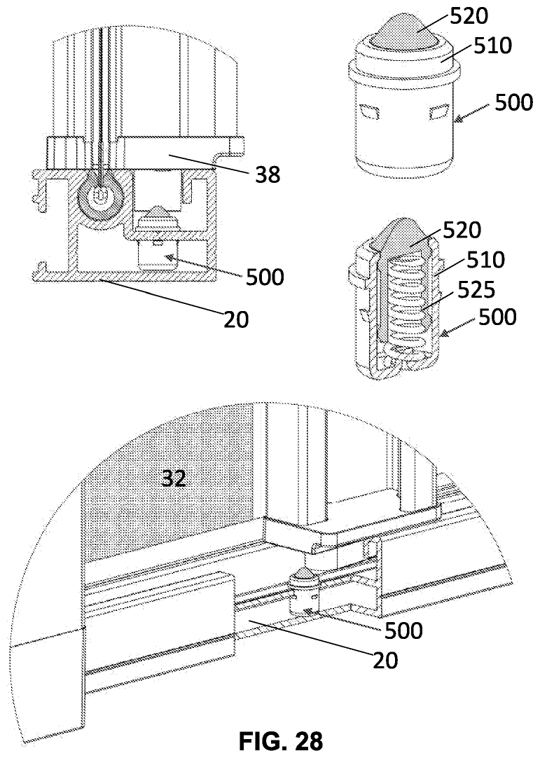

FIG. 25 is a partially cut away view of the lower roller housing 14 in which the rotary damper assembly 204 is disposed. The rotary damper assembly 204 has a body filled with a viscous fluid for damping the force applied by the torsion spring. The rotary damper assembly 204 includes an upper end cap 242 that fits over the spring 250. A ring 244 with external ribs 246 is at the top of the end cap 242. The ribs 244 are configured to cooperate with recesses in the internal surface of the roller 200 for rotation therewith. The lower part of the rotary damper assembly 204 includes an end cap 260 with a base 264 and an upstanding spindle 262. 30 The respective upper and lower parts of the rotary damper assembly 204 are spaced apart and are flexibly coupled by a spring 250 in the form of a coil spring. The spring 250 has three sections, an upper section 252, an intermediate section 254 and a lower section 256. The upper section 252 has a constant first diameter configured to fit over the lower section 256 of the damper, the lower section 256 has a constant second diameter less than the first diameter to fit over the spindle 262 and the intermediate section 254 has a reducing diameter from the first diameter to the second diameter. The spring 250 may be cut to size to assemble roller housings 14 of different length. This 5 enables a roller housing 14 to be easily cut to size on site. A washer 270 separates a base 264 from the spring 250. FIG. 27 shows a detail of the lower end cap 28, lower attachment member or connector 208, and end cap 260. Parts can be interchanged to assemble either right-handed or left-handed screens as both the spring assembly 202 and the rotary damper assembly 10 204 may be joined to the same upper end cap 26 or lower end cap. The end cap 260 is in turn mounted onto the connector 28 by means of an annular hexagonal projection 266 in the base 264 (shown in FIG. 27) being received within the complementary hexagonal recess 237 in the connector 28. It will be appreciated that the connector 28 and lower end cap 28 are identical to the 15 upper end cap 26 and tension adjuster 206 as described above.

Referring to FIG. 28, an optional drawbar engaging member 500 is provided to allow the screen to be left in an intermediate open/closed position. Like reference numerals describe features that have been previously described in earlier sections. The engagement member 500 comprises a spring-loaded member 520 that is biased by a spring 525 and retained within a cylindrical body 510. During installation, the drawbar engaging member 500 may be positioned at any location along the top rail 18 or bottom rail 20. In the preferred embodiment, the intermediate member 500 is located within the channel 102 of the bottom rail 20 to engage with end cap 38 that forms part of the draw bar assembly 16. The spring loaded member 520 comprises a convergent configuration (conical) which allows the end cap 38 to contact and travel past the spring loaded member 520 during an initial opening operation. During such an opening operation, a structure positioned at one of the underside of the end cap 38 pushes the spring loaded member 520 in a downwardly direction as the end cap 38 travels past the engaging member 500 when the latch assembly is engaged. When the latch is no longer engaged, the end cap 38 catches the spring loaded member 520 and prevents the screen from returning to the fully open position.

Now that embodiments have been described, it will be appreciated that some embodiments may have some of the following advantages:
Embodiments may be adjusted to suit different sized screens, and this allows the frame to be cut to a required size at an installation site.
Friction due to some degree of installation misalignment can be compensated for on site.
The retraction tension can be adjusted without disassembling the screen.
The tension can be adjusted using standard tools, including standard drivers, and thus no special tools are needed. A power tool is generally not needed.
Each turn of the driver turns one end of the spring once, and so spring tension is quickly increased (unlike earlier designs that were tensioned with a drill requiring multiple revolutions). Consequently, the number of turns can be easily counted so iterative adjustments are easier to make.
The intertwined threads provide multiple engaging parts to increase strength. 30 The step rake on the threads may enable quick disengagement for tensioning, and a “self seating” feature.
The hook of the latch may be biased onto the latch keeper without the need for extra springs. It is relatively easy to manually pivot the latch to disengage from the latch keeper.
Clips may make it easy to mount the retractable screen and release the retractable screen from the clips. It may be easier to take the retractable screen down if necessary and then put it up again. There is freedom to choose where to attach the mounting clips.
Pre-tensioning the torsion spring may not require that the entire end cap to be rotated. In order to adjust the tension of an installed screen, it may not be necessary to remove the end cap.
The latch member may double as the guide member thereby simplifying 10 construction (and reducing cost). There may be no moving parts associated with the draw bar extrusion. This may allow the draw bar to be cut to size.
There may be no additional latch engagement members or the like on the receiver bar extrusion, thereby providing no limitation as to how the drawbar extrusion may be cut to size.
The bias of the latch member to the closed position is improved by the tension of the screen, further minimizing the number of moving parts.
The mounting clips allow for easier installation. Further, as the mounting clips are separably mountable to the screen frame members, the mounting clips may be mounted in the desired locations depending upon the relative dimensions of the respective frame members.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A screen retraction mechanism for a retractable screen assembly, the screen retraction mechanism comprising:
a roller housing;
a roller spinably mounted within the roller housing and for rolling a screen material sheet thereon;
a torsion spring coupled to the roller for rotationally biasing the roller;
a rotary damper assembly in rotary engagement with the roller; and
a tension adjuster coupled to an end of the torsion spring and configured to move in and out of engagement with the roller housing, wherein the tension adjuster is spinnable to selectably tension the torsion spring when out of engagement with the roller housing;
wherein the tension adjuster and the housing are cooperatively configured for dis engageable threaded engagement.

2. A screen retraction mechanism as claimed in claim 1, comprising a torsion spring assembly comprising the torsion spring, and an end piece disposed at an end of the torsion spring, the end piece being in rotary engagement with the roller.

3. A screen retraction mechanism as claimed in claim 2, wherein the end piece is slidingly received within an end of the roller.

4. A screen retraction mechanism as claimed in claim 2, wherein the torsion assembly comprises another end piece disposed at another end of the torsion spring and coupled to the tension adjuster.

5. A screen assembly as claimed in claim 1, wherein an end of the rotary damper is slidingly received within the roller.

6. A screen retraction mechanism as claimed in claim 1, wherein the housing comprises an end cap, wherein the end cap and the tension adjuster are cooperatively configured for dis-engagable threaded engagement.

7. A screen retraction member as claimed in claim 1, wherein the tension adjuster comprises a thread having less than a pitch of thread.

8. A screen retraction mechanism as claimed in claim 1, wherein the tension adjuster comprises a plurality of intertwined threads.

9. A screen retraction mechanism as claimed in claim 8, wherein each of the plurality of intertwined threads has less than a pitch of thread.

10. A screen retraction mechanism as claimed in claim 1, wherein the torsion spring can be selectively tensioned to bias the tension adjuster inwards and into threaded engagement with roller housing.

11. A screen retraction mechanism as claimed in claim 1, wherein the roller housing comprises a longitudinal slot shaped screen material port.

12. A screen retraction mechanism as claimed in claim 1, wherein the tension adjuster is externally operable.

13. A kit of parts that can be assembled into a screen retraction mechanism, the kit comprising: a roller housing; a roller for spinably mounting within the roller housing and for rolling screen material sheet thereon; a torsion spring for coupling to the roller for rotationally biasing the roller; a tension adjuster for coupled to an end of the torsion spring and configured to move in and out of engagement with the roller housing, wherein the tension adjuster is for spinning to selectably tension in the torsion spring when out of engagement with the roller housing, wherein the tension adjuster and the housing are cooperatively configured for dis engageable threaded engagement; and a rotary damper assembly for rotary engagement with the roller.

14. A method of assembling a screen retraction mechanism, the method comprising the steps of: attaching a sheet of screen material to a roller for rolling the sheet of screen material thereon; spinnably mounting the roller within a roller housing; coupling the roller to a torsion spring; coupling a tension adjuster to the torsion spring; unthreading the tension adjuster from the housing; operating the tension adjuster to selectively tension the torsion spring; coupling the roller to a rotary damper assembly; and engaging the tension adjuster to the roller housing; threading the tension adjust with the housing.

15. A method as claimed in claim 14, wherein the step of operating the tension adjuster comprises the step of externally operating the tension adjuster.

16. A method as claimed in claim 14, wherein the step of spinnably mounting the roller within the roller housing comprises disposing the roller between a plurality of roller housing end caps.

17. A method as claimed in claim 16, wherein the step of engaging the tension adjuster to the roller housing comprises engaging the tension adjuster to one of the plurality of end caps.

18. A method as claimed in claim 14, wherein the step of operating the selectable tensioner comprises selectively tensioning the torsion spring to bias the tension adjuster inwards and into threaded engagement with roller housing.

19-40. (canceled)
